(19) United States
(12) Patent Application Publication
(10) Pub. No.: US 2010/0129507 A1
(43) Pub. Date: May 27, 2010

(54) Edible Adhesive Coatings For Multi-Component Food Products

(75) Inventors: Jareer Abu-Ali, Bakersfield, CA (US); Gary Moore, Johnsburg, IL (US)

Correspondence Address: BANNER & WITCOFF, LTD.;and ATTORNEYS FOR CLIENT NO. 006943, 10 SOUTH WACKER DR., SUITE 3000, CHICAGO, IL, 60606, US

(73) Assignee: The Quaker Oats Company, Chicago, IL (US)

(21) Appl. No.: 12/693,729

(22) Filed: Jan. 26, 2010

Related U.S. Application Data
(62) Division of application No. 11/400,567, filed on Apr. 7, 2006.

(51) Int. Cl. A23P 1/08; A23P 1/02

(52) U.S. Cl. 426/292; 426/293

(57) ABSTRACT

This invention relates to edible adhesive coatings for multi-component food products, methods of making edible adhesive coatings, food products comprising these edible adhesive coatings, and methods to make multi-component food products comprising edible adhesive coatings; and particularly to edible adhesive coatings for multi-component food products, methods of making edible adhesive coatings, food products comprising these edible adhesive coatings, and methods to make multi-component food products comprising edible adhesive coatings where one of the functions for the edible adhesive coating is to facilitate adhesion of particulate components, such as grains or granola pieces, to a base component, such as a food-based center. This invention, in one embodiment, provides an edible adhesive coating comprising a source of edible fat, a hygroscopic food powder, and optionally an emulsifier. In specific embodiments, the hygroscopic food powder is a dietary fiber, such as polydextrose, and the emulsifier is lecithin. The source of edible fat can be any typical source, including compound coatings and chocolate coatings. Other embodiments of the present invention provide methods to make edible adhesive coatings, methods to make food products using edible adhesive coatings, and food products comprising edible adhesive coatings.

### FIELD OF THE INVENTION

This invention relates to edible adhesive coatings for multi-component food products, methods of making edible adhesive coatings, food products comprising these edible adhesive coatings, and methods to make multi-component food products comprising edible adhesive coatings; and particularly to edible adhesive coatings for multi-component food products, methods of making edible adhesive coatings, food products comprising these edible adhesive coatings, and methods to make multi-component food products comprising edible adhesive coatings where one of the functions for the edible adhesive coating is to facilitate adhesion of particulate components, such as grains or granola pieces, to a base component, such as a food-based center.

### BACKGROUND OF THE INVENTION

To rapidly bring to market foods that satisfy a variety of consumer needs and wants requires that companies have the flexibility to efficiently develop and implement a wide spectrum of food product designs. Convenience products, such as easy to eat snacks, are in high demand in today's fast paced environment. Furthermore, consumers vary in what they look for in convenience products. For example, some consumers may prefer savory products, other consumers prefer sweet products, others seek out nutritional products, and others desire performance-enhancing products. To meet the ever-evolving desires of today's consumer, in today's competitive environment, where vast combinations of flavors, textures, shapes, sizes, and nutritional profiles are just some of the variables to consider, food product developers and engineers try to find common technological platforms useful to make a variety of products.

One platform useful to design a wide range of food products is the use of fat-based coatings applied to, or combined with, additional food components. Such fat-based coatings can function to hold together other food pieces or components. Typically, a fat-based coating is heated to a temperature where it is liquid or semi-liquid. The coating is then applied to a base food piece, such as a puffed or extruded center. Then, after the coating has been applied, additional components, such as a component of particulates (e.g., grains or granola) can be added. In other words, the coating can function as an adhesive medium, holding together other food pieces or components.

A drawback of presently available fat-based coatings is that they function as an adhesive medium only after the coating has been first cooled to a point where it is has become more solid and thicker in consistency. Therefore, a food manufacturing process using this presently available type of fat-based coating must incorporate a cooling step after the coating has been applied, but before the particulates or other components are added. Alternatively, other presently available coatings are designed to have relatively thick consistencies at application, even without cooling. These latter coatings are usually made with a refining process where the fat and other ingredients of the coating are processed through a roller refining apparatus. Such coatings, that are thick in consistency at application, may not properly flow into and cover nooks and corners of irregularly shaped food pieces. In either case, the ability of these previous coatings to function as an adhesive medium depends on the coating having a thick consistency. The thick consistency becomes a drawback when coatings are required to coat and cover nooks and infiltrate corners of food pieces that are irregular in shape. Additionally, as mentioned above, making traditional fat-based coatings requires a refining step when making the coating.

Therefore, there is a need for an adhesive coating that is convenient to make and apply. There is also a need for an adhesive coating that can function as an adhesive medium even when the coating has a relatively thin consistency, and that can be conveniently used with irregularly shaped food pieces. Also, there is a need for an adhesive coating that does not require refining to make the coating, or that does not require a cooling step for it to function as an adhesive medium. Finally, since fat-based coatings contain a high proportion of fat, an additional need is that such coating provide some nutritional benefit.

Accordingly, it is an object of the present invention to provide an edible adhesive coating that is convenient to make and use.

A further object of the invention is to provide an edible adhesive coating that is effective in holding together particulates, or other food components, even when the coating is of relatively thin consistency.

A further object of the invention is to provide an edible adhesive coating that does not require cooling to function as an adhesive medium.

A further object of the invention is to provide an edible adhesive coating that can be conveniently applied onto irregularly shaped food pieces or components.

A further object of the invention is to provide an edible adhesive coating that contains dietary fiber.

A further object of the invention is to provide an edible adhesive coating that can function as a common platform in the design of a multi-component food products.

### SUMMARY OF THE INVENTION

With these and other objects in view, this invention, provides edible adhesive coatings that can be used together with other food components or food pieces, in the design of multi-component food products. In one embodiment, this invention provides an edible adhesive coating comprising a source of edible fat, a hygroscopic food powder, and optionally an emulsifier. In a specific embodiment, the source of edible fat is a compound coating. In an additional embodiment, the source of edible fat is a chocolate coating. These are only two examples of sources of edible fat that can be used to make the edible adhesive coatings of this invention.

In another embodiment, the hygroscopic food powder of the edible adhesive coating is a dietary fiber. In a more specific embodiment, the dietary fiber is polydextrose. Additionally, embodiments of the edible adhesive coating can comprise an emulsifier. A specific embodiment is provided where the emulsifier is lecithin.

A further embodiment provides an edible adhesive coating comprising from about 10% to about 90% of a source of edible fat, from about 10% to about 20% dietary fiber, and from about 1% to about 5% emulsifier.

Another embodiment of this invention provides a method of making edible adhesive coatings without the need to refine the blended mixture of fat, hygroscopic powder, and optional emulsifier.

An additional embodiment of this invention is to a method of making multi-component food products comprising at least partially coating a food piece with an edible adhesive coating to make an at least partially coated food piece. Another embodiment to the method of making multi-component food products further comprises adding a particulate component to said at least partially coated food piece.

Another embodiment of this invention covers multi-component food products made from the above mentioned processes and formulations.

An additional embodiment of this invention teaches an agglomerated food product made with the edible adhesive coating of this invention.

### BRIEF DESCRIPTION OF THE DRAWING

FIG. 1a is a diagram of a multi-component food product for illustrating aspects of this invention;

FIG. 1b is an illustration of a multi-component food product having an odd-shaped center which can be produced with the edible adhesive coatings of this invention;

FIG. 2 is a flow diagram showing a method of making a multi-component food product in accordance with this invention;

FIG. 3 shows how an agglomerated food product can be made in accordance with the present invention.

### DETAILED DESCRIPTION OF THE INVENTION

The aspects, features and advantages of the present invention will become better understood with regard to the following description with reference to the accompanying drawings. What follows are preferred embodiments of the present invention. It should be apparent to those skilled in the art that these embodiments are illustrative only and not limiting, having been presented by way of example only. All the features disclosed in this description may be replaced by alternative features serving the same purpose, and equivalents or similar purpose, unless expressly stated otherwise. Therefore, numerous other embodiments of the modifications thereof are contemplated as falling within the scope of the present invention as defined herein and equivalents thereto.

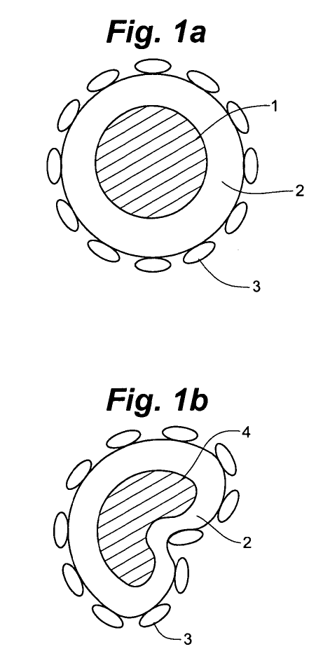

The present invention relates to edible adhesive coatings, the method of making such coatings, the use of such coating to make multi-component food products, and multi-component food products containing edible adhesive coatings. FIG. 1a illustrates a typical multi-component, or multi-piece food product for illustrating aspects of this invention. FIG. 1a shows a three component food product having a center 1, an edible adhesive coating 2, and an external component of particulates 3. FIG. 1a is merely illustrative of a type of multi-component food product that can be made according to the present invention, and one skilled in the food product arts can appreciate the wide variety of product designs that can be achieved using the teachings of this invention. FIG. 1b an illustration of a multi-component food product having an odd-shaped center which can be produced with the edible adhesive coatings of this invention. FIG. 1b is merely illustrative of a type of multi-component food product that can be made according to the present invention. FIG. 1b also demonstrates an advantage of the edible adhesive coatings of this invention, in that they can be used to make multi-component food products wherein the coated component has an odd or irregular shape. Again, while FIGS. 1a and 1b show a three component system, with a center 1 or 4, an edible adhesive coating 2, and a component of particulates 3, many possible designs can be made with the edible adhesive coatings taught. For example, an additional, non-limiting product design is an agglomerate, where a quantity of food pieces is coated with the edible adhesive coating of the present invention, and then compacted or formed into a product. In such a design, the food pieces can be all the same type of food piece (e.g., all puffed rice), or the food pieces can be a mixture of different types of food pieces (e.g., a granola-type mixture). An even further non-limiting product design is where a food piece, such as a grain-based flake, is coated with the edible adhesive coating of the present invention. Again, these designs are merely exemplary of the many product designs possible. Also, the degree or amount of coating for any design can vary, so that a food piece can be totally covered with coating, or partially covered with coating.

Therefore, as can be readily appreciated by those skilled in the food product arts, any product design where the adhesiveness of a coating is desirable, can incorporate the edible adhesive coatings of the present invention. A product design can incorporate any type of food piece, to be coated (or partially coated), such as a center, with an edible adhesive coating. The food product design can incorporate an additional component, such as an additional layer (or partial layer) of particulate food pieces. Where an additional component is incorporated, the edible adhesive coating functions to hold all the components together (e.g., hold the particulates to the centers).

Where the product design includes a center component, a wide range of center components can be used. The center component can be soft, hard, or intermediate in hardness. The center component can be spherical, or it can be of other regular or irregular shapes. Non-limiting examples of center components include fruit pieces (e.g., dried or semi-soft fruit pieces), extruded or otherwise baked or expanded grain-based centers, grain-based flakes, confectionery pieces, nuts, gels, gum, and other sweet or savory food pieces.

Where the product design includes a component of particulates, many different types, sizes, and shapes of particulates can be used. Non-limiting examples of particulates include fruit pieces, extruded or otherwise baked or expanded grain-based pieces, confectionery pieces, nuts, gels, gum, and other sweet or savory food pieces. Common particulates include grains or mixtures of grains, including but not limited to granola-type mixtures.

Where the product design is an agglomerate of food pieces, many different types, sizes, and shapes of particulates can be used. Non-limiting examples of particulates include fruit pieces, extruded or otherwise baked or expanded grain-based pieces, confectionery pieces, nuts, gels, gum and other sweet or savory food pieces. Common particulates include grains or mixtures of grains, including but not limited to granola-type mixtures.

The edible adhesive coatings of the present invention are fat-based coatings made by combining a source of edible fat with hygroscopic powders, and optionally an emulsifier. Any typical source of edible fat can be used, including a wide variety of vegetable and animal fat sources. The edible fat source can be fat(s) in a relatively pure state, containing no other, or relatively few other ingredients. Alternatively, the source of edible fat can be a previously made blend of fat and other ingredients (e.g., compound coating, chocolate coating, or other ingredient blend containing fat). Specific examples of fats and sources of edible fat include, but are not limited to, hydrogenated and unhydrogenated vegetable oils, palm kernel fats, cocoa butter, interesterified fats, fractionated fats, and solid or semi-solid animal fats. Recommended fats include cocoa butter, cocoa butter substitutes, cocoa butter equivalents, hydrogenated soybean oil, hydrogenated cottonseed oil, and blends thereof. Other non-limiting examples of fat sources include compound coatings (including lauric and non-lauric compound coatings), chocolate coatings (e.g., milk chocolate, white chocolate, semi-sweet, or dark chocolate-based coatings), super compound coatings, coatings created through the addition of a hard fat to chocolate or compound coatings, or other common sources of fat or fat-based blends. The fat content of an edible adhesive coating of this invention can range generally from about 10% to about 90%. More preferably, the fat content of the edible adhesive coating of this invention has a fat content from about 15% to about 30%.

The hygroscopic powders for the edible adhesive coating of this invention include a wide variety of food powders. Preferred embodiments contain dietary fiber. Dietary fiber adds nutritional value to products made with the edible adhesive coatings of this invention, and also contributes to the adhesive properties of such coatings. A specific embodiment contains polydextrose as the dietary fiber. The product, Litesse®, by Danisco, is a preferred form of polydextrose. Other non-limiting examples of dietary fiber include resistant starch, oligofructose, oat bran, beta-glucan and inulin. The fiber content of the edible adhesive coating of this invention can range generally from about 5% to about 20%. More preferably, the fiber content of the edible adhesive coating of the present invention ranges generally from about 10% to about 15%.

The adhesive properties of the high adhesive coatings of this invention can alternately be achieved by adding other hygroscopic powders in addition to, or instead of, the dietary fiber. Such powders include, but are not limited to, maltodextrins, modified and unmodified starches, dairy powders, protein concentrates (dairy, soy, or other), powdered lactose, corn syrup solids, and other sugars, carbohydrate, or protein-based powders. The powders can be pre-refined powders, granulates, or can be used in other typical powdered forms.

The edible adhesive coating can also be made with the addition of emulsifier. While emulsifiers are not necessary, use of an emulsifier allows the design and formulation of a coating having a combination of properties most advantageous to the product and process of interest. For example, by using emulsifier together with a hygroscopic powder, the suitable level of adhesion can be achieved at a desired coating consistency at a specific temperature. When emulsifiers are included in the edible adhesive coating, the emulsifier is added last, after the source of edible fat and hygroscopic powder(s) have been mixed together. Non-limiting examples of emulsifiers useful for the edible adhesive coating of the present invention include all types of lecithin (including hydroxylated variations, and not limited to phosphatidyl choline), PGPR, distilled mono & diglycerides and mixtures thereof, acetylated glycerides, soy proteins, and stearates.

When no emulsifier is used, the edible adhesive coating formulation must contain at least 30% fat. Also, when no emulsifier is used, the fat in the formulation should be semi-solid at room temperature. Fats with melting points below 98 F are preferable. In general, the fat should be chosen to avoid Bloom and specification.

In addition to a source of edible fat, hygroscopic powders, and emulsifiers, other ingredients can optionally be added to the coating formulations. Common additional ingredients include flavoring ingredients (in liquid or powdered forms), colorants, sugars, cocoa liquor, non-hygroscopic food powders, and seeding agents.

To make the edible adhesive coating of this invention, the source of edible fat is heated to a point where it is generally liquid or semi-liquid. Then, the powder or dry ingredients are added and mixed together with the liquid or semi-liquid fat. Where the edible adhesive coating includes an emulsifier, the emulsifier is mixed in last. This process can all occur in a common processing kettle. A kettle with temperature control is useful, but not necessary. A key feature in making the edible adhesion coatings of this invention is that the coating formulation (i.e., the coating blend) need not be refined. In fact, an advantage of the edible adhesive coatings of the present invention over previous coatings is that, while the previous coatings used for similar purposes are typically refined with a roller refiner apparatus, the coatings of this invention are made without the need to refine the coating blend. Avoiding a refining step to make the edible adhesive coatings of the present invention allows the coatings to be more effective as an adhesive medium at relatively thin consistencies.

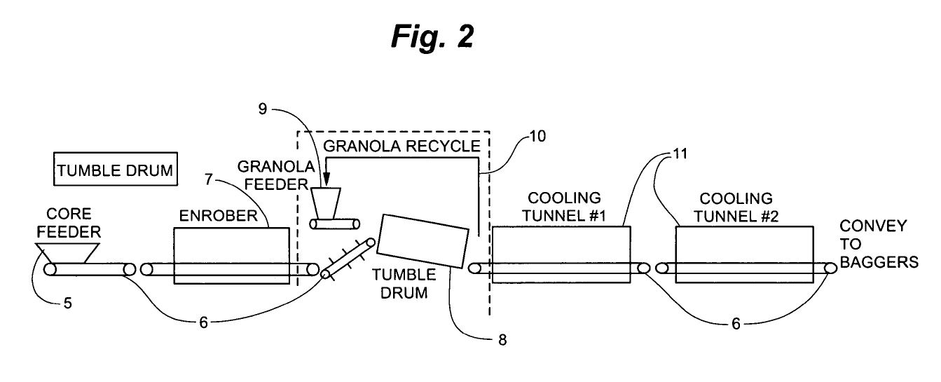

Once an edible adhesive coating is made, a food product using the coating can be produced. A typical food product design incorporating the edible adhesive coating may contain several components (or food pieces), such as a center, an edible adhesive coating, and a component of food particulate pieces. FIG. 2 illustrates an exemplary tumbledrum process for making a multi-component food product using the edible adhesive coating. In this exemplary tumbledrum process, a quantity of center component pieces is stored in the core feeder 5. The core feeder 5 drops the center component pieces (the centers) onto a conveyor system 6, which carries the centers through an enrober 7. A conveyor system can be designed to have several different conveying sections depending on the process and layout of the manufacturing line. Also, the conveying sections can have belts that are solid, belts that are made from wire, belts made from metal, rubber or polymeric materials, belts that allow drainage of coating or particulates through gaps or slots in the belts, belts with sectioned walls for carrying materials upward, belts that move at different speeds, or other features.

The enrober 7 stores the edible adhesive coating in a heated, liquid or semi-liquid state, and applies the edible adhesive coating onto the centers. Temperatures of the coating and the enrober will vary depending on the fat source used for the edible adhesive coating. According to product design, the centers can be completely covered, or only partially covered with the edible adhesive coating. For example, the enrober can be set up to top enrobe, top and side enrobe, bottom enrobe, or completely enrobe. One skilled in food product arts will understand that enrobers can be set up for various applications. Alternatively, the enrober can be replaced with some other type of equipment to apply the coating. A non-limiting example of a different coating application system is one that drizzles or sprays the coating onto the centers. Additionally, the enrober can be equipped with a mechanism, such as blowing air, to remove excess coating from the coated or partially coated centers.

Once the coated centers exit the enrober 7, they are conveyed into the tumbledrum 8, where the coated centers are mixed together with the component of particulates. In FIG. 2, the component of particulates is stored in a feeder 9, which drops the particulate component (e.g., granola) onto the enrobed centers. The particulates can immediately adhere onto the enrobed centers, or fall onto the conveyor. The particulates (both loose particulates and adhered particulates) and the coated centers then enter the tumbledrum 8 together. Alternatively, in other possible embodiments, the component of particulates and the coated centers can be transferred separately into the tumbledrum 8. The tumbledrum 8 is a rotating piece of equipment where the coated centers and the particulates are mixed to promote contact between the particulates and the coated centers. In the tumbledrum 8, loose particulates have opportunity to contact the enrobed centers to further ensure proper adhesion of the particulates to the enrobed centers, and to achieve the desired degree of coverage by the particulates. Once the enrobed and particulate-covered pieces exit the tumbledrum 8, unadhered particulates are recycled via a recycling system 10, while the coated and particulate covered centers pass through one or more cooling tunnels 11 to cause the coating to solidify and set.

Using the edible adhesive coating of this invention, the particulates more effectively hold onto the coated centers leaving the tumbledrum 8, so that fewer particulates fall off and need to be recycled. The cooling, then, sets the particulate pieces that have already adhered onto the coated centers. Therefore, in FIG. 2, the cooling step is separate from the coating or mixing steps, and comes after the particulate pieces have already been adhered onto the coated centers. The cooling step is therefore not essential to ensuring initial adherence of the particulate pieces onto the coating centers. Other processes within the scope of this invention could apply an earlier cooling step, at or before the mixing step (e.g., tumbledrum 8), so that adhesion is achieved by both the adhesive properties of the novel edible adhesive coating of this invention, along with the setting effect caused by cooling. Additionally, we incorporate by reference the teaching of provisional patent application entitled “Improved Tumbledrum Design And Method For Coating Objects” which is filed concurrently with this application.

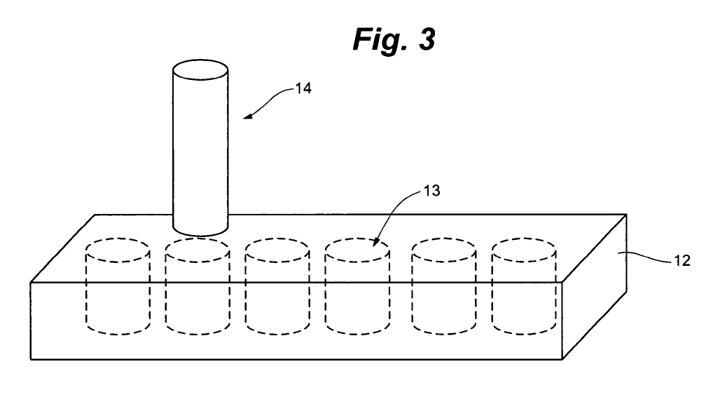

The process in FIG. 2 is a non-limiting exemplary process showing how a typical multi-component food product can be made with the edible adhesive coating of the present invention. As can be appreciated by one skilled in the food product arts, any process for applying the coating to a food piece can be used. Whether mixing to promote contact is required depends on product design. In FIG. 2, mixing in a tumbledrum is used to promote and control contact between the coated centers and the component of particulates. Other types of equipment can be used to mix or promote contact between a coated food piece and food pieces. Furthermore, other types of equipment can be used to both promote contact and to create different product designs. For example, FIG. 3 shows a mold and plunger approach to compact a quantity of coated food pieces to make an agglomerated food product. In such a process, a quantity of already coated food pieces is filled into a molding system, such a mold tray 12 having cavities 13 to receive the already coated food pieces, and the already coated pieces are then compacted with the plunger 14 to form a product. The shape and sensory characteristics of the product will depend, in part, on the coating used, the food pieces used, the amount of coating applied, the shapes of the molds used, and the amount of compaction applied. Again, FIG. 3 is merely exemplary of a contacting process, and also merely exemplary of how an additional product design can be made using the edible adhesive coating of this invention.

### DESCRIPTION OF EXAMPLES OF THE INVENTION

The following examples are merely illustrative of the present invention and should not be considered as limiting the scope of the invention in any way.

### Example 1

### Chocolate Compound Coating (for Use as a Source of Fat for Making an Edible Adhesive Coating to be Applied in a Temperature Range of about 98 F to about 126 F).

| | | |
|---|---|---|
| Partially Hydrogenated Palm | 22-32% | by weight |
| Kernel Oil: | | |
| Sugar: | 54-64% | by weight |
| Cocoa powder | 12-17% | by weight |
| Non Fat Dry Milk | 2-7% | by weight |
| Lecithin | <2% | by weight |
| Salt | <2% | by weight |
| Artificial flavor | <2% | by weight. |

### Example 2

### Edible Adhesive Coating Formulation

| | |
|---|---|
| Compound Coating | 87% by weight |
| Polydextrose | 10% by weight |
| Lecithin | 3% by weight. |

### Example 3

### Edible Adhesive Coating Formulation

| | |
|---|---|
| Compound Coating | 87% by weight |
| Maltodextrin | 10% by weight |
| Lecithin | 3% by weight. |

### Example 4

### Edible Adhesive Coating Formulation

| | |
|---|---|
| Compound coating: | 87-95% by weight |
| Polydextrose: | 5-10% by weight |
| Palm Kernel Oil: | 0-3% by weight. |

1-7. (canceled)

8. A method of making an edible coating on a food piece, where the edible coating has improved adhesive properties, comprising:
a. first, blending a source of edible fat with a hygroscopic powder to provide a coating blend; and,
b. then, applying said coating blend to said food piece.

9. The method of claim 8, further comprising the step of mixing an emulsifier into the coating blend of step a., before performing step b.

10. The method of claim 9, wherein the emulsifier is lecithin.

11. The method of claim 8, wherein the source of edible fat is a compound coating.

12. The method of claim 8, wherein the source of edible fat is a chocolate coating.

13. The method of claim 8, wherein the hygroscopic powder is dietary fiber.

14. The method of claim 8, wherein the hygroscopic powder is polydextrose.

15. A method of making a multi-component food product comprising:
a. providing an edible adhesive coating comprising from about 10% to about 90% of a source of edible fat and from about 10% to about 20% dietary fiber;
b. providing a food piece; and,
c. at least partially coating the food piece with the edible adhesive coating of step a to make an at least partially coated food piece.

16. The method of making a multi-component food product of claim 15, wherein said food piece is a center.

17. The method of making a multi-component food product of claim 15, further comprising adding a component of particulates to said at least partially coated food piece.

18. The method of making a multi-component food product of claim 17, wherein said component of particulates is granola.

19. The method of making a multi-component food product of claim 18, further comprising mixing the component of particulates and the at least partially coated food piece to make an at least partially coated and covered food piece.

20. The method of making a multi-component food product of claim 19, further comprising cooling the at least partially coated and covered food piece.

21. The method of making a multi-component food product of claim 15, further comprising:
a taking a plurality of said at least partially coated food pieces; and,
b. agglomerating said at least partially coated food pieces.

22. The method of making a multi-component food product of claim 21, wherein the agglomerating step comprises: a. molding said at least partially coated food pieces.

23. The method of making a multi-component food product of claim 21, wherein the agglomerating step comprises: a. compacting said at least partially coated food pieces.

24-26. (canceled)
